(19) United States
(12) Patent Application Publication
(10) Pub. No.: US 2014/0180755 A1
(43) Pub. Date: Jun. 26, 2014

(54) Identifying, Assessing, And Tracking Black Swan Risks For An Engineering And Construction Program

(71) Applicant: FLUOR TECHNOLOGIES CORPORATION, Aliso Viejo, CA (US)

(72) Inventor: Robert Prieto, Princeton Junction, NJ (US)

(73) Assignee: FLUOR TECHNOLOGIES CORPORATION, Aliso Viejo, CA (US)

(21) Appl. No.: 14/135,457

(22) Filed: Dec. 19, 2013

Related U.S. Application Data
(60) Provisional application No. 61/745,234, filed on Dec. 21, 2012.

(51) Int. Cl. G06Q 50/08; G06Q 10/06

(52) U.S. Cl. CPC G06Q 50/08; G06Q 10/0635
USPC 705/7.28

(57) ABSTRACT

A risk analysis system having a risk analysis engine that can identify a set of risks for a program based on a constructed program model. The program model can be based on known, historical programs using current program attribute information. The risks can be identified by executing one or more simulations using the program model. The outcome of the simulation can be used to identify individual drivers of risk, which can in turn be used to identify one or more previously undetected and unanticipated black swan-level risks facing the program.

This application claims benefit of priority to U.S. provisional application No. 61/745,234 filed on Dec. 21, 2012. U.S. provisional application 61/745,234 and all other referenced extrinsic materials are incorporated herein by reference in their entirety.

### FIELD OF THE INVENTION

The field of the invention is management systems for large multi-project engineering and construction programs.

### BACKGROUND

The background description includes information that may be useful in understanding the present invention. It is not an admission that any of the information provided herein is prior art or relevant to the presently claimed invention, or that any publication specifically or implicitly referenced is prior art.

Private and public entities increasingly are undertaking large scale capital construction programs utilizing a program management approach. The growing scale, complexity and durations of these programs require the use of a comprehensive and integrated management system incorporating features, techniques, work processes and tools not found in current project management tools. These entities typically engage external entities to provide various elements of these program management services but no comprehensive integrated management system exists today.

Key features required in the management of the delivery of these large programs include identifying, assessing, modeling, analyzing, forecasting, tracking, managing and reporting on a wide range of outcomes, outputs, processes, constraints and drivers. Currently, strategic business objective tracking, governance assessment and strategy phase activities are not addressed in existing management systems. Additionally these efforts have been confined to the capital project delivery phase and not extended into initial operations and long term operations and maintenance.

Furthermore, features of existing project management systems which are often employed in a program management context currently lack the owner perspective, which is the key differentiator between projects and programs.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus there is a need for a project management system capable of identifying potential black swan risks at a program level.

### SUMMARY OF THE INVENTION

The inventive subject matter provides apparatus, systems and methods in which attributes of a current program can be used with historical models of programs to simulate program execution, and identify potential, undiscovered risks to the program.

One aspect of the inventive subject matter includes a risk analysis system comprising a program database, a risk database and a risk analysis engine. The program database can store historical program objects representative of previously executed programs. These historical program objects can be used as templates or representative examples for a program or program type. The historical data objects can comprise program event features, which can be considered to represent the individual components, features, characteristics, and/or parameters of the program.

The risk database can be configured to store risk objects representing risks, each risk object having risk drivers representative of the characteristics of the risk. The risk drivers can be considered to represent the characteristics that can give rise to a risk and to increase its magnitude.

The risk analysis engine can be configured to select a historical program from the program database to use as a reference program. The risk analysis engine can then use the reference program as the basis to construct a program model, such as by using current program attributes to populate the program event features of the reference program.

Having generated the program model, the risk analysis engine can execute one or more simulations using the program model to generate a program outcome. The program outcome can be considered to represent a quantified result or effect of the program, such as a status of the program after the simulation, an event, and a measure of a program objective against a simulation goal (e.g., the purpose of the simulation itself) or against a program objective (e.g., one or more goals or objectives of the ‘real-life’ program). The simulations that the risk analysis engine can execute to generate the program outcome can include one or more of Monte Carlo simulations, a Failure Mode and Effects Analysis (FMEA) simulation, a Fault Tree Analysis (FTA) simulation, and a scenario analysis simulation. The generated program outcome can include outcome factors, which can be considered the characteristics or features of the program outcome. In embodiments, the outcome factors can be one or more of the program event features as populated by current program attributes of the program model, as affected by the simulation. In embodiments, the outcome factors can be one or more of the program event features as populated by current program attributes of the program model, that have an effect on the execution of the simulation, and the outcome of the simulation.

The risk analysis engine can identify one or more of the outcome factors of the simulation as program risk factors. These can be considered the outcome factors that can impact the outcome of a program, such as by being those factors that can most affect the outcome of a program or that are most vulnerable to being affected by disruptive events.

The identified program risk factors can be used by the risk analysis engine to derive a set of risks. The set of risks can be derived as a function of risk objects having risk drivers that satisfy criteria depending on the program risk factors. In embodiments, the risk analysis engine can derive the set of risks by using a risk identification algorithm that can have a bias in seeking long-tail, low-probability events. The set of risks can represent black swan risks.

In embodiments, be a collection of risks, risk statistics associated with the risk objects or the risk drivers satisfying the criteria, correlated risks, and chained risks.

In embodiments, the set of risks can be newly identified risks represented by newly generated risk objects. These risk objects can be generated by the risk analysis engine based on identified risk drivers.

The risk analysis engine can be configured to present the set of risks to the user, such as by causing an output device (e.g., display, audio output, etc., of a computing device) to present the set of risks to the user.

In embodiments, the system can include a recommendation module that can generate a recommendation for presentation to the user, based on the identified set of risks. The recommendation can include a financial instrument to mitigate the identified risks. The recommendation can include recommendations regarding one or more modifications to one or more aspects of the program to a user that can serve to mitigate the risks identified in the set of risks.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 provides an overview of an example system executing functions and processes associated with the inventive subject matter.

FIG. 2 is an example of the generation of a program outcome using a Failure Mode and Effects Analysis (FMEA) simulation.

FIG. 3 is an example of the generation of a program outcome using a Fault Tree Analysis (FTA) simulation.

FIG. 4 is an example of the generation of a program outcome using a scenario analysis simulation.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

One should appreciate that the term “program” as used herein is considered to mean a collection of one or more projects, construction projects for example, rather than a software application. A program can include multiple projects underway in parallel, projects operating serially, multiple project phases, or other collection of activities. Although the following discussion main relates to large scale engineering or construction programs, it is noted that the disclosed techniques can also be applied to other types of programs. Other types of programs can include software development programs or implementation of human resource programs, just to name a few.

Much has been written on black swan-type risks, sometimes treated as the risks from unknown unknowns. However, black swan risks represent a key risk ontology not currently considered in the engineering and construction industry. This raises the following questions: do black swans inhabit the world of program management and are they truly unknown unknowns?

The term “black swan” comes from 16-17th century Europe. At that time, all observable swans were white, and by extension all swans were therefore assumed to be white. No non-white swan had ever been observed, and so the black swan was presumed not to exist. At the end of the 17^{th} century, however, black swans were discovered in Western Australia, and that discovery undermined the statistics of swans to that date. Previously, the “likelihood” of observing a black swan was essentially nil, but, upon recognition that the improbable was not the same as the impossible, the “observability” of black swans became more likely. What had changed that made black swans more probable? Simply put, perceptions were broadened. The search for black swans included searching places that had not been previously searched or considered.

Large programs, by their very nature, move into a new “neighborhoods” where previously rare “unknown unknowns” are more prevalent, or more likely given program scale, complexity, and durations. In effect, large program risks can grow in new non-linear ways. For example:
Program scale and complexity moves the into a new “neighborhood” where black swans may be more common;
scaling drives non-linear and non-correlated growth in risks;
complexity masks existing risks; and
complexity creates new risks.

Nassim Nicholas Taleb, in his 2007 book “The Black Swan”, describes “black swans” as events with the following three attributes:
“First, it is an outlier, as it lies outside the realm of regular expectations, because nothing in the past can convincingly point to its possibility.
Second, it carries an extreme impact.
Third, in spite of its outlier status, human nature makes us concoct explanations for its occurrence after the fact, making it explainable and predictable.”

In hindsight, one can always argue that a black swan was a knowable unknown. Most importantly, it is important to consider Taleb's first point, namely of an outlier “outside the realm of regular expectations.” Programs demand that we change this definition of “regular” in order to narrow our exposure to unknown unknowns.

Increasingly large programs introduce levels of complexity that provide convenient territory for black swans to breed and nest. These events lie outside the realm of regular expectations. Thus, reducing black swans in program management can be approached by attempting to turn as many knowable unknowns into known unknowns. In a program context, effective risk management is about limiting the neighborhoods where black swans can be by more rigorously examining these potential breeding and nesting grounds (knowing more) and, most importantly, building in resiliency.

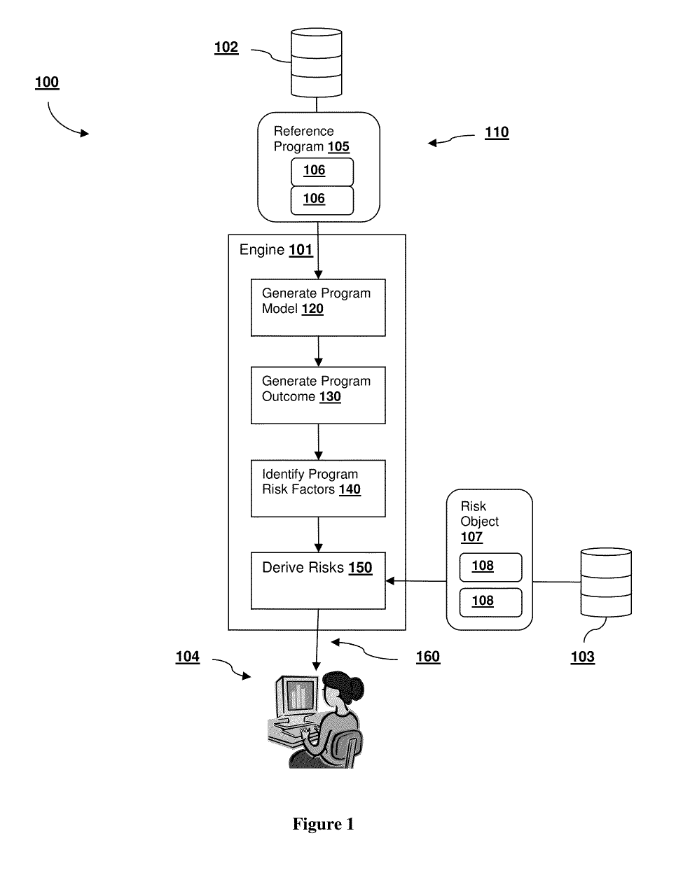

FIG. 1 provides an overview of a system 100, used to carry out functions and processes associated with the inventive subject matter.

As shown in FIG. 1, the system 100 can include a risk analysis engine 101, communicatively coupled to a program database 102, a risk database 103, and a user interface 104.

In embodiments, the risk analysis engine 101 can be embodied as computer-executable instructions stored on a non-transitory computer-readable storage medium (e.g., RAM, ROM, hard-drive, flash drive, solid-state drive, optical media, etc.) that, when executed by a computer processor, causes the processor to a carry out the processes and functions of the inventive subject matter associated with the risk analysis engine 101. In embodiments, the risk analysis engine 101 can be embodied as specialized computer processor specifically programmed to carry out the functions and processes of the inventive subject matter associated with the risk analysis engine 101.

The program database 102 can be embodied as a non-transitory computer-readable storage medium (e.g., hard-drive, optical media, solid state drive, server computer, etc.). The program database 102 is configured to store historical program objects, such as historical program object 105, each historical program object representing a historical program. As used herein, a “historical program” is intended to refer to an a priori known program. As such, “historical program” can refer to implemented and executed programs (and can include successful programs and failures) as well as planned programs (that have not yet been executed), executed simulated programs, and template programs (e.g., a “baseline” or “example” construction of a program or a part of a program).

Historical program objects can include program event features 106. The program event features 106 can represent aspects, parameters, and/or characteristics of historical programs represented by historical program objects. Historical program objects can also include program features such as identification features (e.g., for indexing, searching, matching, correlating purposes, etc.), and other metadata features. The program event features 106 can include program event feature fields that can be populated with values. In embodiments, the program event features 106 of the stored historical program objects can be populated with null values prior to their use in the processes and methods of the inventive subject matter.

In embodiments, one or more of the program event features 106 can be constraint coupling features. Constraint coupling features can be considered to be “linking” features between programs. The constraint coupling features can be features common across multiple program objects, representing common program aspects or characteristics across multiple programs. In embodiments, constraint coupling features can include features of a program object that have a “cause and effect”, a hierarchical, dependency, or parent-child relationship with features of a different program object.

In embodiments, one or more of the program event features 106 can be objective features. Objective features are representative of program objectives. The objectives can include global objectives for a program as a whole, progress objectives, phase objectives, program sub-section objectives (e.g., objectives applicable to a sub-component of the program), budget objectives, production objectives, efficiency objectives, etc.

The risk database 103 can be embodied as a non-transitory computer-readable storage medium (e.g., hard-drive, optical media, solid state drive, server computer, etc.). The risk database 103 can be configured to store risk objects representing risks. Each risk object 107 can include one or more risk drivers 108, which can be considered to represent a characteristic of the risk represented by the risk object 107. In embodiments, the program database 102 and risk database 103 can be the same database storing both historical program objects and risk objects.

In embodiments, the risk database 103 can be updated with bespoke risk objects in real-time. As risk objects are generated, they can be added to the risk database 103 for use by the risk analysis engine 101. In an example, a user can, via the user interface 104, create a new risk object by selecting risk drivers from an available list of risk drivers. Upon completion, the new risk object can be added to the risk database 103. In another example, the user interface 104 can enable a user to modify an existing risk object by adding, removing, or modifying one or more risk drivers. The modified risk object can be updated in the risk database 103 in real-time to reflect the changes made by the user.

The user interface 104 enables a user to interact with the other components of the system 100. The user interface 104 can be a computing device (e.g., desktop computer, laptop computer, tablet, smart phone, etc.) having input interfaces (e.g., keyboard, mouse, touch screen, microphone, camera, etc.) and output interfaces (e.g., display, speakers, sensory feedback components, etc.), and communication interfaces allowing for data exchanges with other components of the system 100. The user interface 104 can also include software applications that allow for the user to input data into the system 100 (such as via one or more of the input interfaces) and receive output data from the system 100 (such as via one or more of the output interfaces).

In embodiments, the user interface 104 can be a web-based interface, accessible via an Internet browser on a computing device, which enables the user to exchange data with the system 100 via the web-based interface.

One or more of the risk analysis engine 101, program database 102, risk database 103, and user interface 104 can be communicatively coupled to one another via data exchange networks such as the Internet, LAN, WAN, VPN, etc., using data communication interfaces such as wired, Wi-Fi, cellular, Bluetooth, NFC, USB, HDMI, etc.

In embodiments, one or more of the risk analysis engine 101, program database 102, risk database 103, and user interface 104 can be integral to a single computing device.

In the example illustrated in FIG. 1, the risk analysis engine 101 can identify a historical program from the program database 102 as a reference program 105, and retrieve the identified reference program from the program database 102 at step 110. The risk analysis engine 101 can be configured to identify a historical program as a reference program in response to a query, such as one by a user submitted via interface 104. The query can include information such as the identification of a program name, a program type, a program category, a program location, a program duration, a program time-frame, a program cost, and a program goal. The query can also include, or be comprised entirely of, one or more program event features from a global list of program event features across multiple historical programs.

At step 120, the risk analysis engine 101 generates a program model by populating one or more of the program event features 106 of the reference program 105 according to corresponding attributes of a current program, wherein the attributes of the current program include attribute values. A current program can be considered to be a program currently enacted, that is in the process of being executed or carried out. The attributes and attribute values can be received from one or more databases storing information regarding current programs. The attribute and attribute value information regarding various current programs can include report data (e.g., data gathered via progress reports, periodic audits, and other assessments of a program's state made during the life of a program), sensor data (e.g., sensor data gathered by sensors of equipment, machinery, etc. used in the program), survey data, location data, budget data, program objective data, organizational data (e.g., data regarding the organization executing the program), etc. In embodiments, some or all of the attributes can be of the same namespace as the program event features, wherein attributes correspond directly to program event features and the attribute values correspond to program event feature values for the current program. In embodiments, one or more of the attributes can be mapped or otherwise correlated to one or more program event features and the attribute values populated to program event features. The mapping can be performed via a clustering or other statistical algorithm.

In embodiments, the current program attributes received by the risk analysis engine 101 do not have to be sufficient to populate all of the program event features of the reference program object. For program event features that are not populated by program attributes, the program model can be constructed by assigning those program event features null attribute values, or a default attribute value corresponding to a “baseline” or “normal” value. In embodiments, the program model can be constructed by excluding the program event features that are not populated by received current program attributes.

In embodiments where one or more of the program event features include constraint coupling features, the program model can be generated based on the program event features and/or the program objects linked via the constraint coupled features. As such, the program model can be generated as a combination of more than one program object, and thus model more than one program or program aspect.

At step 130, the risk analysis engine 101 generates a program outcome representative of a program outcome by executing one or more simulation of the program using the program model. The program outcome can be considered to represent a quantified program result or effect of the program. In embodiments, the program outcome can be embodied as a program outcome object. The program outcome object can include outcome factors, which can represent characteristics or aspects of the outcome.

The simulations used by the risk analysis engine 101 can include one or more of a Monte Carlo simulation, a simulation based on Failure Mode and Effects Analysis (“FMEA”), a simulation based on Fault Tree Analysis (“FTA”), and a scenario-based simulation.

The risk analysis engine 101 can generate the program outcome by executing more than one simulation, with the same parameters or different parameters. By executing more than one simulation, the risk analysis engine can build a collection of simulation and output statistics. These simulations can be run with the same or different parameters for a particular program model, and the statistics relative to each simulation run collected and compiled.

In embodiments, the program outcome object can comprise an outcome event object, representing an event caused by the simulated program execution. Examples of events include a program process executed as a result of the simulation, a transition to a new program phase, an alert, a warning, and a program shutdown.

In embodiments, the program outcome can comprise an intermediary status. The intermediary status can be an indication of the status of the program at a simulated point in time in the program's lifetime corresponding to the executed simulation, and as a result of the simulation. The outcome factors for an intermediary status outcome can be representative of the status of various aspects of the program at this simulated point in time, in response to the simulation. In an aspect of these embodiments, the program outcome can be the program model as affected, changed or otherwise modified by the simulation, with the outcome factors corresponding to the program event features (optionally including the current program attributes populating the program event features) as modified or affected by the simulation. As such, the outcome factors can include information associated with the amount of change in the corresponding program event features and/or their current program attributes. In an aspect of these embodiments, the intermediary status outcome can correspond to the state of the program model in response to the simulation, with the outcome factors corresponding to the program event features (optionally including the current program attributes populating the program event features) as they contributed to the outcome of aspects of the simulation and the ultimate outcome of the simulation itself. The outcome factors can include information associated with the corresponding program event feature's influence with regard to the simulation outcome.

In embodiments, the program outcome can comprise a measure of an objective. The objective can be a measured objective of the simulation, such as how the program outcome according to the simulation compares to simulation benchmarks. The objective can be a measured objective of the program at the simulated point in time relative to one or more objectives of the program. The program objectives can include global objectives, such as the ultimate goals of a program, as well as smaller program objectives (e.g., objectives of particular program phases, aspects or subsections of a program, objectives of individual processes within the program, etc.).

At step 140, the risk analysis engine 101 identifies program risk factors from the outcome factors resulting from the executed simulations. Program risk factors can be considered those that factors that could affect or impact a program outcome. The identification can be performed according to rule sets that can be applied depending on factors such as the program model type and the simulation(s) used in generating the program outcome. The rule sets can include identifying outcome factors as program risk factors based on a ranking or a comparison to an established threshold. For example, in the embodiments having outcome factors corresponding to post-simulation program event features as affected by the simulation, the risk analysis engine 101 can identify program risk factors as the outcome factors having been most affected or changed by the executed simulation from their pre-simulated state. The number of risk factors to be identified can be user-designated, or can be set based on a required or desired number of risk factors necessary to generate a usable set of risks. In another example of the same embodiment, outcome factors meeting a certain threshold of change from their pre-simulation state can be designated as program risk factors. The ranking and threshold rule sets can be combined such that a set number of program risk factors are identified, with the requirement that all of the program risk factors meet a particular threshold.

At step 150, the risk analysis engine 101 derives a set of risks based on the identified program risk factors.

In embodiments, the risk analysis engine 101 can derive the set of risks by using a risk identification algorithm having a bias in seeking long-tail, low-probability events. For example, the risk identification algorithm can be configured to seek high-impact, low-probability events in the tail of a Monte Carlo analysis.

In embodiments, the risk analysis engine 101 can derive the set of risks by identifying one or more risk objects 107 stored in the risk database 103 having risk drivers 108 satisfying criteria associated with the program risk factors. In one example, a characteristic of a risk driver can be mapped to an associated characteristic of program risk factor (e.g., according to characteristics such as risk driver type, risk factor type, program type of the program risk factor, etc.), and to a criteria of the program risk factor that triggers a flagging of the risk driver based on the mapping to the program risk factor. The criteria can include a threshold magnitude or other indication of severity of the program risk factor. As such, if a program risk factor is of a sufficient magnitude, the risk analysis engine 101 can incorporate the risk driver mapped to the program risk factor into the creation of the set of risks. In another example, program risk factors can be grouped according to characteristics via clustering analysis or other statistical analysis, and one or more risk drivers identified based on criteria associated with the clustered group, such as common characteristics of the clustered program risk factors.

In embodiments, having identified risk drivers, the risk analysis engine 101 can derive the list of risks by identifying risk objects 107 associated with one or more of the risk drivers. The set of risks can be a collection of one or more risks represented by the identified one or more risk objects 107.

In embodiments, the risk analysis engine 101 can group the identified risk drivers (such as via clustering or other statistical grouping), and generate new risk objects based on the groups of risk drivers. The set of risks can then be derived from the newly-generated risk objects.

In embodiments, the set of risks can include risk statistics. The risk statistics can be the statistics of the particular risks in the set of risks as relevant to the program.

In embodiments, the set of risks can be a chain of risk objects 107. Chained risk objects can be considered those having direct links, wherein the presence of one risk indicates a strong probability that associated risks will be present or will become present. Chained risks can also be sequential, wherein a particular risk, left unmitigated, will give rise to a next risk in the chain. In chained risks, it is not necessary to have a commonality between all of the risks in the chain, only between two links so as to keep the chain “connected”.

In an embodiment, the set of risks can be in the form of one or more new risk objects. Newly-created risk objects can then be stored in the risk database 103, serving to update the risk database 103.

In an embodiment, the set of risks can be a set of black swan risks. In one example, a set of risks derived from a generated group of risk objects based on risk drivers that were previously considered to be uncorrelated can be considered black swan risks, as they can be considered to represent previously unknown risks. In another example, existing risks for one program can be black swan risks for another program, as they can be risks that were previously unanticipated for this other program.

In embodiments, the derivation of set of risks can include a ranking of risks. For example, the risks can be ranked according to the impact of each risk, a probability of occurrence of each risk, or the frequency of occurrence of each risk within the executed simulations. The ranking can be generated based on more than one ranking criteria, whereby the risk analysis engine 101 can weight each ranking criteria according to a pre-defined weighting criteria in calculating a risk ranking score for each risk within the set. The risks within the set can then be ranked according to the risk ranking scores.

At step 160, the collected set of risks can be passed from the risk analysis engine 101 to an output device, such the user interface 104, for presentation to the user.

In embodiments, the system 100 can include a recommendation module. The recommendation module can be configured to receive the set of risks from the risk analysis engine 101, and generate a mitigation recommendation based on the set of risks. The mitigation recommendation can be a financial instrument, such as a financial instrument providing indications of potential financial implications of allowing the risks to continue unmitigated, as well as the financial costs associated with mitigating one or more of the risks in the set of risks to varying degrees.

In embodiments, the recommendation can include identification of aspects of a program that can be changed to mitigate the identified risks. For example, recommendations can include the identification of new supply chain solutions, modified capital expenditure profiles, and changed engineering and procurement cycles.

In embodiments, the set of risks derived by the risk analysis engine 101 and/or the risk objects 107 stored in the risk database 103 can correspond to correlated risks. Correlated risks can be considered risks having an association or relationship with another risk such that a change in one risk causes a corresponding change in another risk. The relationship can be linear or non-linear, and directly or inversely proportional. The correlation between two correlated risks can be mono-directional or bi-directional. In embodiments, correlated risks can be directly correlated, whereby a change in one risk directly results in a change in the correlated risk. In embodiments, the correlated risks can be correlated via a chain of risks, where a change in a first risk will affect a risk directly linked to it, which will in turn affect a risk linked to it, in the chain, until the effect propagates to the correlated risk. The following are examples of correlated risks that would be represented by risk objects, and their corresponding risk drivers.

A first example of a correlated risk comprises common global demand drivers for natural resources and primary materials. Large, rapidly growing, developing countries represent emerging market-shifting drivers for materials of construction. As these emerging economic powerhouses move through the various stages of development, underlying market drivers are likely to shift in more dramatic ways than have been previously seen. Price points are likely to shift dynamically and spot market volatility likely to increase, reflecting the time lag between growing demand and the ability to increase supply of these basic materials. Industrial policy in countries such as China and India can impact cost and schedule of major capital construction programs across all industries around the world. The risk drivers in a risk object associated with this correlated risk can include risk drivers representing observed increases in demand for materials in a country or region, anticipated lag between demand growth and corresponding supply increase (e.g., based on observed lags in past growth of varying amounts, industry trends, etc.), published market analyst predictions of growth by a country or region, local government action likely to affect growth, etc.

A second example of a correlated risk is the correlated risks associated with energy security. Growth in worldwide demand for energy, driven in large part by the common global drivers described above, carries with it an additional risk driver whose importance has grown as marginal industry capacity is increasingly absorbed. This additional risk driver is associated with potential threats to energy security from both state and non-state actors.

Energy flows through the Straits of Hormuz and Mallaca are growing (currently over half of all seaborne oil), and they are increasingly vulnerable to disruption from terrorist, piracy, or accidental events. State actors, such as Russia and Venezuela, with an ability to disrupt already stretched global energy flows have shown an increased willingness to wield their supply concentration power. To reflect these areas of potential risk, the risk drivers for risk objects associated with this correlated risk can include risk drivers associated with terrorist threat assessments, political climates (e.g., political ideologies, economic policies, political relationship with large energy-consuming countries, ability and/or willingness to assist with security, etc.) in energy producing regions and/or along energy transportation routes, short- and long-term weather predictions in energy producing regions and/or along energy transportation routes, level of infrastructure in place to withstand destructive events, amount of energy produced by a region or country, etc.

A third correlated risk example is that of shortage of heavy marine transport. Major capital construction programs depend on an increasingly globalized and networked supply chain. This supply chain can extend around the world and is increasingly managed utilizing the latest tools in logistics management. For the engineering and construction industry, much of the supply has traditionally required travels through this supply chain on heavy marine transport. New construction strategies of prefabrication and modularization as well as the reconfiguration of the world's heavy industrial base carry with a requirement for specialized heavy marine transport. Today's mega-project needs to increasingly understand the logistics risks of movement of the materials of supply from source to use and actively manage risks that were often unseen, hidden away in often ignored shipping schedules. As such, the risk drivers for risk objects associated with this correlated risk can include risk objects associated with availability of adequate heavy marine transport, capability of a shipping route to accommodate heavy marine transport, capability of ports to accommodate heavy marine transport, etc.

A fourth correlated risk example deals with supply disruption due to natural events in major areas of supply. In the engineering and construction environment of yesterday, adequate stockpiles and overall industrial capacity existed such that disruptions in supply due to natural events were often seldom felt and where of a relatively transitory nature at worst. This is not the case today, as demand has stretched certain key industries to capacity and global stockpiles are limited relative to global demand levels (for example, less than a three month supply for most base metals). Many areas that represent critical raw, intermediate, or final supply sources are vulnerable to the disruptive effects of natural events or disasters. The risk drivers associated with this risk factor can include risk drivers associated with a type of natural event, a predicted damage to the local area, an estimate disruption in supply by amount, an estimated disruption in supply by time (e.g., timeframe to become fully operational once again), etc.

For example, the following potential scenarios can have a significant impact on major construction programs globally:

A major cyclone causes extensive damage to iron ore exporting facilities in Western Australia. The risk drivers for this example can include an estimated risk of the extent of damage to iron ore mining facilities, export facilities (e.g., disruption of land transport routes, disruption of seaports, etc.), remoteness of facilities (e.g., the ability for reconstruction efforts in terms of material and manpower to be deployed), local jurisdictional response, etc.

A Katrina-like hurricane destroys refinery capacity on a scale comparable to or in excess of that experienced after Hurricane Katrina. Risk drivers for this example can be based on lessons learned from Hurricane Katrina, including risk drivers associated with time to recovery, disruptions in refinery production capacity (e.g. due to repair, due to manpower availability, due to infrastructure damage to region supporting refinery, due to jurisdictional/governmental concerns post-event, etc.), accessibility to refineries post-event, etc.

A major earthquake cause destructive damage to copper exporting ports in Chile and Peru. Risk drivers for this example can be based on historical earthquake data from the region, and can include local regulatory efforts for earthquake preparation, local compliance/enforcement of earthquake preparation requirements, estimated time/capacity disruption based on magnitude of earthquake, effect of earthquake on shipping capabilities, etc.

Each of these natural event risks is a real possibility. Each carries with it a global impact to mega-construction projects worldwide.

A fifth correlated risk example is associated with a flawed industry financing model. Correlated risks can deal not only with the physical demands of large-scale engineering and construction programs, but also with financial, human, and other risks that are perhaps not as immediately evident. Risk drivers in this example can be associated with an entire financing model, such as multiple banks, insurance providers, builders, suppliers, etc., of multiple geographic locations or regions. The risk drivers for this correlated risk can be associated with one or more aspects of financial models that are currently not well-understood, or those that carry the risk of mis-management (e.g., due to lack of regulatory or industry oversight, due to “traditional” ways of doing things lacking adaptability, the mentality of “too big to fail”, etc.). Other risk drivers can include those associated with risk-assuming parties and their abilities to absorb and/or transfer risks as they materialize, and objectively recognizing leverage potential of complex project financing structures at various levels (including attempts by international accounting standards that seek to recognize and quantify this so called off balance sheet debt).

A sixth correlated risk example is associated with supply chain “friction” from global events of scale. In the last decade, events such as SARs, bird flu, and the increased security regimes that flowed from the attacks of Sep. 11, 2001 have impacted the efficiency of movement of people and goods. The world is increasingly networked, and events in one region or part of the world can affect supply chain both globally and permanently. Risk drivers associated with this correlated risk can include those associated with the “trickle-down” effect that an event in one region has globally. These risk drivers can include a level of interconnection between a region and one or more supply chains, the strength of a particular region as a “link” in a supply chain, a priority of a particular supply chain in a hierarchy of global networks (e.g., communication networks, transportation networks, etc.), the amount of disruption predicted for a particular supply chain per region, the amount of disruption predicted for a supply chain per event, etc.

A seventh correlated risk example is associated with a general disruption of one or more major supply chains. In the past, concerns were limited to localized labor strife or political expropriation, principally at construction sites. Today, disruptions can occur globally, including in areas other than our sources of supply or sites of construction, and the impacts can be as severe as the risks are unobvious. The risk drivers associated with this correlated risk can include risk drivers associated with factors that can snowball into the disruption of a supply chain. For example, a strike in a shipyard in Korea might delay a specialized marine vessel required for delivery of modules fabricated in China for use in a project in Australia. In another example, changed visa regimes may limit third country labor supply necessary to complete fabrication of components for a major project supplier. A tsunami in Japan, like that which hit the Fukishima region, can disrupt critical industrial component flows. As such, the risk drivers can include labor conditions in various regions, local governmental concerns and attitudes, vulnerability of inputs to a supply chain to catastrophic events, etc.

An eighth correlated risk example is associated with the failure of critical infrastructure. Existing infrastructure is in a state of decay, and only growing worse by the day. The current physical infrastructure remains susceptible to single point failures, such as at major river crossings, or as a result of networks lacking flexibility, adaptability, or responsiveness. However, outright catastrophic physical failure is not the only risk factor associated with infrastructure failure. The degraded condition of physical infrastructure components can also result in “deratings” of the components. For example, a bridge can be derated from 12 tons to 3 tons due to degradation. As such, the bridge previously accessible for crossing by a 10-ton supply truck is now inaccessible. Risk drivers associated with this correlated risk can include assessed infrastructure conditions, including age of infrastructure components, maintenance state of infrastructure components, current rating of infrastructure components, vehicle dependency on infrastructure component (e.g., a vehicle of a particular size, weight, vehicle type, cargo type, etc., using a particular route because of ratings of route infrastructural components), availability of alternate routes for a particular transport (e.g., size, weight, type of cargo, type of vehicle, etc.), anticipated traffic changes to alternate routes due to temporary or permanent infrastructure failures, bottlenecks created by infrastructure components, infrastructure downtime due to scheduled repairs, estimated infrastructure downtime due to failure, etc.

A ninth example of correlated risk is directed to the emergence of new risks associated with changed requirement. On a general level, this class of risks is not new because all change carries risks associated with the change. This correlated risk is directed to changes being made today, that may carry risks to projects and project participants that are not yet fully appreciated or properly allocated. Some of these concerns have been observed, as Building Information Models (BIM) blur the roles and responsibilities of the various project participants.

Another, perhaps an even more important, example of emerging risks associated with changed requirements can be seen in the new category of “green risks.” Emerging local sustainability laws introduce a new layer of project compliance with failure to fully achieve compliance resulting in impaired tax benefits, occupancy rates, or the premium rates that might be otherwise obtained for leases. Risk drivers associated with these green risks include local jurisdictional culture (e.g., the predictability of local sustainability laws, frequency and nature of changes to these laws, etc.), dependence of a project on meeting compliance (e.g., reliance on tax benefits or other benefits accorded by achieving LEED certification for viability of a project, etc.), uncertainties regarding the party or parties responsible for assuming a risk if a “green” project fails to achieve LEED certification, the definition of the standard of care that designers must exercise in seeking LEED certification, unexpected delays caused by the LEED process, a lack of availability of specified “green” products as this portion of the supply chain ramps up its capacity, etc.

A tenth example of correlated risk is associated with asynchronous program management (in industrial applications) and supply chain (e.g. networked supply chain) models. Large capital construction programs continue to become increasingly complex. Historical command and control models of management, first devised to support repetitive assembly line style, discrete operations, are inadequate for current programs. Centralized command and control structures will be increasingly challenged, with persistent micro-management or extended decision making time frames constituting a formula for failure. The management of today's large capital construction programs must be more “organic” in nature, with feedback mechanisms helping inform and shape actions throughout what will increasingly be an organic program. As an unwillingness or inability of management to adapt can be the source of repeating failure, this disconnect between management models and project execution opportunities can be considered to be one of the biggest and most severe correlated risk that a project can face.

Risk drivers associated with this correlated risk can include a degree of adaptability in program management, degree of interconnection between program management and supply chains, degree of incorporation of feedback structures into future decision-making, current management skills present in management structure, existing lag between decision-making and execution, an ability of current management structure to acquire new management skills, etc.

Correlated risk objects stored in the risk database 103 and associated risk drivers can be updated through a dynamic scan of the external environment to both identify new potential correlated risks as well as monitor a range of factors influencing and influenced by these potential correlated risks.

As discussed above with regard to step 130, to generate a program outcome, the risk analysis engine 101 can execute one or more simulations based on a program model. In embodiments, the simulations available to the risk analysis engine 101 can include a Monte Carlo simulation, a Failure Mode and Effects Analysis (FMEA) simulation, and a Fault Tree Analysis simulation (FTA).

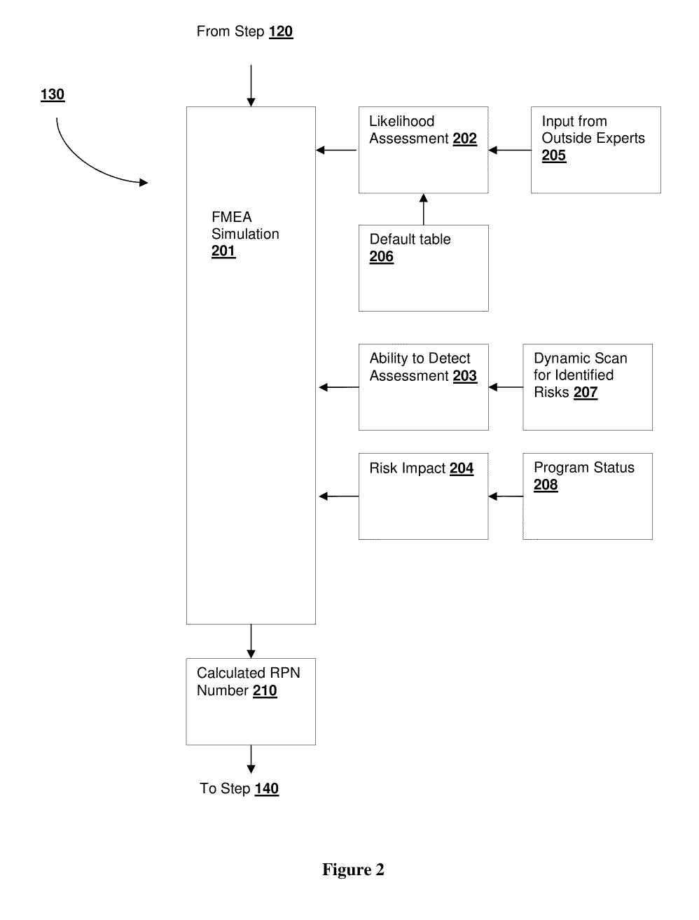

FIG. 2 provides an illustration of step 130, implementing a Failure Mode and Effects Analysis (FMEA) simulation to generate a program outcome.

FMEA incorporates some considerations similar to those used in a Monte Carlo analysis, namely severity and probability of a particular failure mode. FMEA, however, introduces one added consideration which is an ability to detect the failure mode or its precursor. This can help increase attention to low-probability, high consequence events in the Monte Carlo tails. It won't eliminate black swan events entirely, but, by redefining expectations, it is possible to at least track some possible imposters. The use of risk-focused FMEA techniques can help prioritize contingency planning efforts at both the outset of the program and as the program evolves over time. FMEA facilitates the consideration of risks which do not lend themselves to traditional probabilistic assessment approaches.

As described above, the risk analysis engine 101 generated a program model at step 120, having program event features of the selected template populated with current program attributes.

To generate the program outcome, the FMEA simulation analyzes the received program model according to a likelihood assessment 202, an ability to detect assessment 203, and a risk impact 204.

In FMEA, the likelihood assessment 202 replaces risk probability. The likelihood assessment 202 can be assigned a level based on one or more of a table of values established at the outset of the program definition process, based on input from expert systems 205 and an embedded default table such as 206 in this. In embodiments, the default table 206 can be used in complementary fashion to the expert system input 205, where default values 206 for likelihood assessment value fields where expert system input data is missing, incomplete, untrustworthy, or otherwise unreliable.

The ability to detect assessment 203 is defined as “the ability to detect the risk event in enough time to plan a contingency and act upon the risk.” The ability to detect a risk event can range from “almost absolute certainty of detecting the risk in adequate time” to “detection allowing for contingency planning and mitigating action is impossible.” These extremes, as well as intermediary levels of ability to detect, can be represented according to a scoring system. The ability to detect assessment 203 can be determined according to the results of a dynamic scan for identified risks 207. In embodiments, the dynamic scan can be a simulated scan, whereby a database can provide data associated with known risk factors or risk drivers of known events. The ability to detect assessment 203 can be based on whether the scan was able to correlate the known risk factors into a detection of the known risk, and if so, how long it took the scan to do so. In embodiments, the scan can be performed by the risk analysis engine 101, by executing the methods and functions of the inventive subject matter using the “known” outcomes for the analysis, and verifying that the outcome reached by the risk analysis engine is consistent with the “known” outcome. In embodiments, the ability to detect assessment 203 can be based on historical lessons learned, such as documented historical program-wide or organization-wide detections of past risks for a particular program, how timely the risk detection occurred, and whether adequate contingency planning and mitigating action was able to be implemented.

The risk impact 204 can be thought of as the characterization of the severity of the risk on one or more aspects of a program, or to the program as a whole. The risk impact 204 can be a calculated value based on one or more parameters of a program status 208 established at the outset of the program.

The product of these three values 202, 203, and 204 yields a risk priority number (RPN) 210, where RPN=Likelihood Assessment Value*Ability to Detect Value*Risk Impact Value.

In embodiments, a risk analysis engine 101 can generate an RPN for each individual program event feature of the program model. The outcome features of the program outcome generated by the risk analysis engine 101 for the program model can be the RPN applied to the current program attributes for each corresponding program event feature. In one example, the RPN can be a scaling value to be used for a corresponding program attribute, whereby the outcome factor is the result of applying the scaling value to the program attribute.

In these embodiments, the risk analysis engine 101 can identify one or more outcome factors, at step 140 as program risk factors in one or more of a variety of ways. In embodiments, the outcome factors having the highest calculated RPN values (e.g., relative to RPN values corresponding to other outcome factors, proportionally higher relative to other RPN values, etc.) can be identified as program risk factors. In embodiments, any outcome factor having RPN values (i.e., prior to application to the program attributes) surpassing a particular threshold for the corresponding program event feature can be flagged as a program risk factor. In embodiments, outcome factor values having the greatest change from their pre-RPN-modified program attributes (e.g., absolutely or proportionally relative to other outcome factors) can be identified as program risk factors. In embodiments, outcome factors that meet or exceed a particular threshold can be identified as program risk factors.

In embodiments, the risk analysis engine 101 can generate an RPN for the program model as a whole, applicable to the populated current program attributes of all of the program event features. To generate the program outcome, the risk analysis engine 101 can apply the RPN to one or more of the program event features of the program model, as populated by the current program attributes. In embodiments, the RPN can considered to be a scaling value applied to the program attributes. In embodiments, the RPN can be scaled to fit the namespace and/or attribute nomenclature of each current program attribute to which it will be applied.

In these embodiments, the risk analysis engine 101 can identify one or more outcome factors, at step 140 as program risk factors in one or more of a variety of ways. For example, outcome factor values having the greatest change from their pre-RPN-modified program attributes (e.g., absolutely or proportionally relative to other outcome factors) can be identified as program risk factors. In another example, outcome factors that meet or exceed a particular threshold can be identified as program risk factors.

FMEA is an inductive engineering technique best used as a “bottoms up” tool, identifying many more causes and failure modes that can result in program level impacts and suggesting modifications to the program execution plan to prevent risks. Used in a “top down” fashion, it can result in only identifying major failure modes.

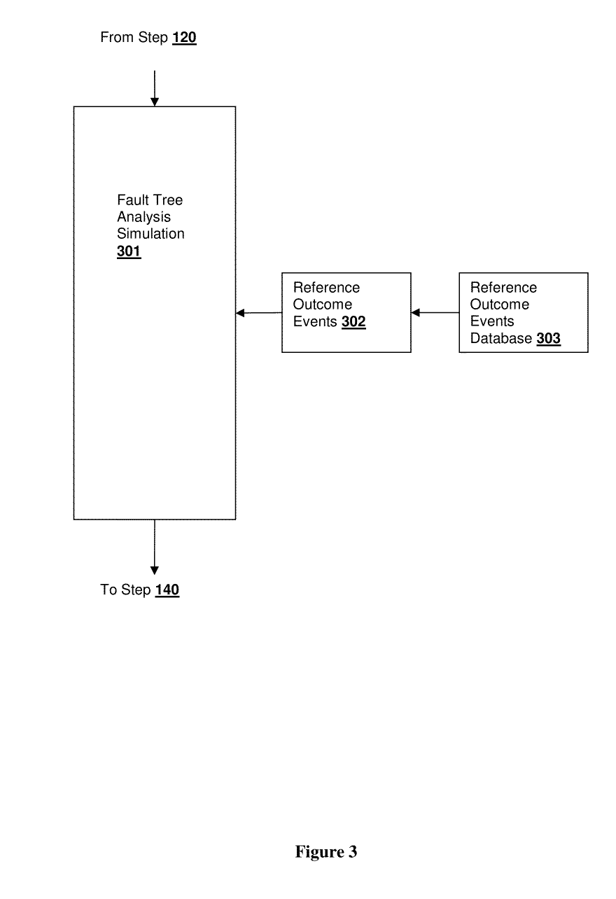

FIG. 3 provides an illustration of step 130, implementing a Fault Tree Analysis (FTA) simulation 301 to generate a program outcome. FTA can be used as a “top down” tool. In embodiments, FTA can be used by the risk analysis engine 101 as the sole simulation. In embodiments, FTA and FMEA simulations can be used in complementary fashion. In embodiments, an interface with existing FTA program modules can be retrieved and provided to the risk analysis engine 101.

In executing the FTA simulation 301, the risk analysis engine 101 can generate a program outcome based on the program model's program event features populated with current program attributes. To do so, one or more reference outcome events 302 for the program model can be selected from a set of reference outcome events stored in a database 303. The reference outcome events 302 can be representative of undesired outcome events for a particular program, and can be data objects having attributes populated by conditions of programs that result in the outcomes. For example, reference outcome events 302 can represent events that cause damage to or the failure of a program. The events represented by the reference outcome events 302 can be ‘general’ events that cause catastrophic, program-wide damage or failure, or can be events causing damage or failure of a particular type or for a particular reason. For each undesired outcome event, the risk analysis engine 101 can create a fault tree and execute it to identify the current program attributes most likely to be affected by negative events, or most likely to contribute to the program's degradation or failure as set forth in the negative program event. Reference program events can be used as inputs to fault trees of other reference program events, and as such, cascading risks of failure can be processed. The reference outcome events 302 used in the FTA simulation 301 can be user selected, or can be selected by the risk analysis engine 101 based on the generated program model, from one or more of the program event features within the program model, and/or from one or more of the current program attributes populating corresponding program event features.

In embodiments, the outcome factors of the program outcome resulting from the FTA simulation 301 can be the program event features populated by current program attributes of the program model, modified to include data associated with their respective contributions to the reference outcome events. For example, a program event feature can include data indicating the level of contribution of the feature (and the corresponding program attribute) to the reference outcome event, the degree that the current program attribute itself contributes to the reference outcome event, a ranking of program event features and/or program attributes ranked by most likely to contribute to an outcome event, etc.

At step 140, outcome factors in program outcomes generated from the FTA simulation 301 can be identified as program risk factors based on their relative contributions to the reference outcome events 302.

Another simulation available to the risk analysis engine 101 is a simulation based on scenario analysis. Real and impactful risk events that do not readily lend themselves to more traditional Monte Carlo analysis must be considered in large, complex engineering and construction programs. Scenario analysis or planning involves aspects of systems thinking, recognizing that factors may combine in complex ways to create surprising outcomes. These outcomes are driven by non-linear feedback loops which can exist both inside complex programs but also in the external environment with which they interact in ever changing and often poorly understood ways. Scenario analysis will not result in the identification of the “right” future; rather it will provide a deeper insight into those elements of a program and risk management strategy that offer the greatest opportunity for resilience in the face of unknown futures. Scenario analysis can be applied to look at the impact of variation in specific parameters outside “normal” ranges but can also be used as a method to “stress test” program project selection and execution plans. It is the considerations of these extremes which lend themselves to identification of black swan susceptibility.

Effective scenario analysis in large programs can vary based on both project level specific variables as well as program-affecting macro-economic or geo-political assumptions. Market uncertainties, varied regulatory outcomes, competitor actions, and unknown unknowns with a range of disruptive effects can all be considered.

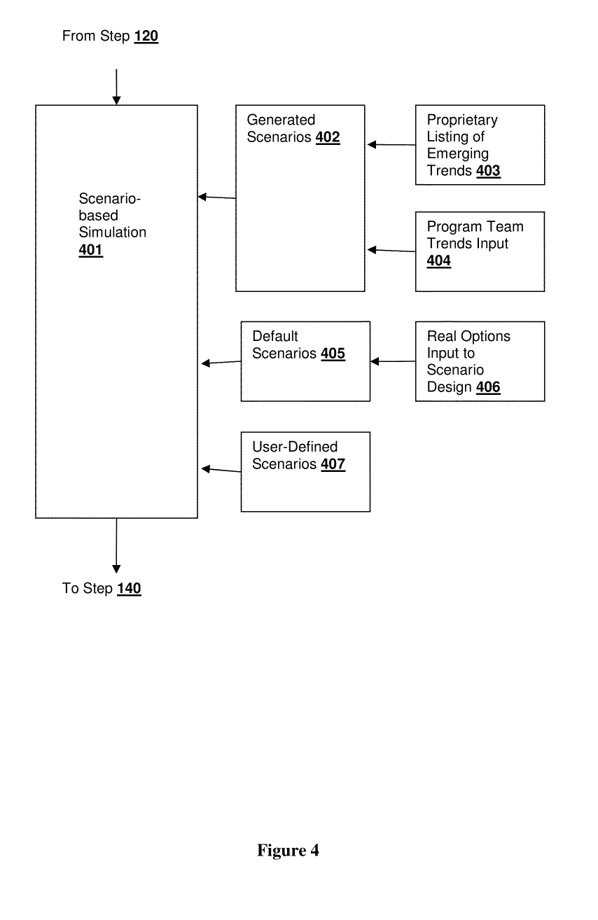

FIG. 4 provides an illustration of step 130, implementing a scenario analysis simulation 401 to generate a program outcome. As shown in FIG. 4, the scenario analysis simulation 401 can be performed based on a program model using one or more of a generated scenario 402, a pre-constructed default scenario 405 and a user-defined scenario 407.

In embodiments, the risk analysis engine 101 can construct a generated scenario 402 from one or more emerging trends 403 from a proprietary list stored in an emerging trends database and one or more program team trend input 404.

The emerging trends 403 can be embodied as data objects stored in the database, representing identified emerging trends. The trend objects can include trend attributes representative of causes and effects of trends. The trends can be based on information gathered from market data, news outlets, industry activity, and other sources.

In embodiments, one or more of the attributes in an emerging trend object 403 can be associated with one or more program event features of one or more historical programs stored in the program database 102 and/or one or more risk drivers of one or more risk objects stored in risk database 103. In embodiments, this association can be based on a same namespace or nomenclature between trend attributes and one or more of program event features and risk drivers. In embodiments, the association can be based on association rules included in the emerging trend object 403, specifying the relationship that the attribute(s) of a particular emerging trend object can have with program event features and/or risk drivers.

The program team trend input 404 can be used to complement the emerging trends 403, and can include input provided by program team members during the program's lifetime. This can be input data associated with observed trend developments by the team members, and can correspond to internal observed trends (i.e., internal to the program), externally observed trends (i.e., outside of the program), or both. The program team trend input 404 can also be used to update one or more emerging trend objects 403.

The following table provides illustrative examples of proprietary emerging trends represented by emerging trend objects. These emerging trends can be collectively grouped under the title “Emerging Trends Impacting the Construction Industry-Next Five Years”, and are emerging trends that can be considered in scenario analysis. As illustrated in the table, the emerging trends can be organized according to a “perspective”, or topic of the trend. In the table below, the emerging trends are categorized according to “economic”, “social”, “political”, “technology”, “industry model” and “program and project management” perspectives.

| Perspective | Emerging Trend |
|---|---|
| Economic | State government deficits and the political pressure to |
| | reduce spending will drive to alternate funding strategies for |
| | U.S. infrastructure. More user fees (tolls) including federal |
| | relaxation of limiting regulations; alternative delivery continues |
| | to grow (PPP—Public Private Partnerships; Design Build); |
| | increased support by Feds on project financing (National |
| | Infrastructure Bank and/or expanded TIFIA program); and tax |
| | enabling policy (tax exempt debt or tax credit bonds). |
| | Real cost gap between U.S. and lower cost manufacturing |
| | centers narrows as wage inflation driven by increased demand |
| | for staples (fuel; food) has larger impact overseas. |
| | National champions play increased competitive role in |
| | international markets (China, Japan, Korea, India, Russia, and |
| | Turkey). |
| | Growth rates in Asia slow to half of current levels. |
| | Strengthening “system” links will be important to economic |
| | health - IT backbone; transmission (power, gas, water); |
| | intercity road and rail. |
| Social | “Green” focus shifts to sustainable actions that produce |
| | measurable financial bottom line impacts. |
| | Population globally in poverty increases as global demand |
| | for food and fuel drives up prices. |
| | Networked society becomes a more global norm and |
| | increases social volatility. |
| | Virtual teams are more commonplace for knowledge-based |
| | work. Current management skills, systems, and processes are |
| | challenged. |
| | “Events of Scale” will increase in frequency. |
| Political | U.S. politics finds common ground on more issues |
| | (spending control; checking the growth in entitlements) but is |
| | much more polarized on other issues (immigration; foreign and |
| | trade policy) as the U.S. seeks to define the kind of nation and |
| | global player it will be in the period ahead. |
| | EU becomes a two-tier structure in reality (core and |
| | periphery) but not in name. |
| | Political change driven by growing poverty and/or economic |
| | disparity unlocks many international puzzle pieces, and there is |
| | great uncertainty as they are reassembled into a new picture. |
| | There will be at least one major regional conflict where the |
| | U.S. will not commit direct combat troops. |
| | Competition and tension between China, Japan, and Korea |
| | will rise significantly. |
| Technology | Networked everything; Smart everything. |
| | Social websites will have a significant workplace impact |
| | even if not sponsored by employers. |
| | Shift from stick built to “manufacturing” (preassembly; |
| | prefabrication; modularization) will extend to many more |
| | industries. |
| | 4D modeling will become a requirement on largest projects |
| | and will increasingly be used for workface planning; fabrication |
| | “specification;” asset management post construction. |
| | Work process technology will have biggest value creation |
| | impact for industry - next generation engineering, procurement |
| | and construction management. |
| | Disruptive process and material technologies will appear |
| | with increased frequency. |
| | Design automation and optimization tools play increased |
| | role. |
| Industry Model | Consolidation along traditional industry business models |
| | will continue with winners having balanced acquisitive and |
| | organic growth. |
| | New industry business models will be tested (alliances; |
| | asset ownership of non-process infrastructure or non-core |
| | assets; life-cycle partnerships/services). |
| | Systemic innovation will become an industry imperative; |
| | Intellectual property gains attention. |
| | Performance specifications will grow in use. |
| | Competition of ideas will become more important (different |
| | solutions to same client need). |
| Program and Project | Risk models must evolve to increase focus on risk drivers; |
| Management | assumption tracking; constraint modeling; failure modes and |
| | effects; scenario modeling; changes to risk profiles and |
| | management over time; low probability/high consequence |
| | events. |
| | Complexity will become an important measure of unseen |
| | risks and will be used to assess project execution plans. |
| | Opportunity analysis, in addition to risk analysis, will be an |
| | important dimension owners are looking for. |
| | Layered design and other contingencies will be more |
| | rigorously sought out to reduce costs. |
| | Change management processes will evaluate optimum time |
| | to implement a change (now, later, commissioning stage, post |
| | commissioning). |
| | More focus on standardizing “details.” |
| | Supply chain and logistics capabilities will become the |
| | prime competitive differentiator. |

In embodiments, the risk analysis engine 101 can execute a scenario-based simulation 401 by applying the program model to a default scenario 405. The default scenarios 405 can be pre-constructed scenarios. The default scenarios 405 can be ‘generic’ scenarios applicable to a plurality of different programs and program types, or can be specialized for particular program types, programs having particular features, etc.

In embodiments, the default scenarios 405 can include previously published, industry-wide or other externally-developed scenarios. Examples of default scenarios of this type can include:
Shell Energy Scenarios: Shell uses scenarios to explore the future. These scenarios recognize that many possible futures exist and will be influenced by the choices individuals and nations make. Their scenario analysis entitled, “Shell Energy Scenarios to 2050,” considers two scenarios called Scramble and Blueprint.
National Intelligence Council Global Trends: “Global Trends 2025: A Transformed World” is the latest unclassified report prepared by the National Intelligence Council (NIC) that takes a long-term view of the future and how key global trends might develop to influence world events.
Davos Scenarios: The World Economic Forum prepares an ongoing series of industry and regional scenarios including both the engineering and construction industry as well as select major markets it serves.

Scenario analysis has a potentially even greater role to play in large, complex programs by opening the door to effective use of “real options” approaches to mitigate risk and capture latent value through strategic flexibility. As such, default scenarios 405 can be constructed or changed according to real options input 406. The real options input 406 can include user-provided limitations on the permutations of a default scenario 405, based on one or more realities of a particular program. The user-provided limitations can include available mitigation options, resources, time frames, etc., to a program for the purposes of responding to an event such as a black swan event. This can be used by the risk analysis engine 101 to mold the default scenario 405 into an program-instance-specific version of the default scenario 405, and enables the simulation 401 to capture the flexibility of a particular program situation to a realistic extent.

The input of real options 408 can result in use of additional scenarios 405 during the simulation 401. The additional scenarios 405 can be combined into the default scenario 405 being considered, or can be chained such that the results of a simulation 401 using the first scenario can be used as inputs to subsequent, additional scenarios. Incorporating the real options 408 creates a level of strategic flexibility in managing program outcomes by exploring the possibilities for a program within the framework of current organizational or program-focused constraints. For large, complex engineering and construction programs, this flexibility may include:
Creating or modifying overall program phasing—Incremental outcomes targets based on success in initial program phases, rates of EBITDA generation
Modifying project phasing—Accelerate, delay, cancel
Output mix flexibility to respond to market uncertainty
Feedstock and material of construction flexibility to respond to inputs pricing uncertainty

In embodiments, the risk analysis engine 101 can execute a scenario-based simulation 401 by applying the program model to a user-defined scenario 407. The system can present a user with a scenario-building tool, such as via interface 104, that enables a user to select from scenario characteristics from which to construct the scenario. The characteristics can include the selection of one or more of a program type, a program duration, a program location, a program goal, a program budget, and a program hazard. The selectable characteristics can also include known external events that can affect a program.

After one or more scenarios 402, 405, 407 have been selected for the simulation, the risk analysis engine 101 can execute the scenario-based simulation 401 based on the program model, according to the selected scenario(s). The program outcome can be the outcome of the simulation, which can include a simulated state or status of the program after the simulation was run, a measure of an objective of the simulation, or an event meeting the criteria of the simulated scenario.

The outcome factors of the program outcome can include program event features of the program model as affected by the simulation. These can include program event features (and, optionally, their corresponding current program attributes) that had an effect in the outcome of the simulation and program event features (and, optionally, their corresponding current program attributes) that were affected by the simulation.

At step 140, the risk analysis engine 101 can identify one or more of the outcome factors as program risk factors based the degree to which they affected or were affected by the simulation. The program risk factors can be selected on a ranked relative or absolute degree by which the outcome factors affected or were affected by the executed by the simulation. A threshold amount can also be used in the selection process, whereby only outcome factors having a threshold amount of effect on the simulation or having been affected only beyond a threshold amount would be selected as program risk factors.

In embodiments where multiple simulation techniques are employed by the risk analysis engine 101, the results from each simulation can be consolidated.

The consolidation can occur after step 130, whereby the outcome factors produced by each simulation can be consolidated. The consolidation can include an aggregation of all outcome factors, a selection of the most relevant outcome factors based on their effects on the generated outcomes, or a selection of outcome factors based on clustering of outcome factors according to the characteristics of the outcome factors. With this approach, the program risk factors can be derived at step 140 based on the consolidated group of outcome factors.

Alternatively, the consolidation can after occur after step 140, whereby program risk factors are identified for each simulation outcome, and a consolidated list of program risk factors is generated. The consolidated list of program risk factors can be an aggregated list of program risk factors, or a selection of program risk factors based on a clustering or other statistical analysis of the characteristics of the program risk factors.

By its very nature, scenario analysis conceives of and models several possible sets of future conditions and then assesses the impacts of these different futures. Some of these futures may represent value creation opportunities if we expand our traditional risk horizons to more fully consider and capture these value creating opportunities. Scenario analysis, together with the other risk analysis undertaken on large programs, can help identify those areas where the program is subject to high levels of dynamic uncertainty and allow testing of different program strategies (timing, risk allocation, and contract options) that can change to better manage these risks as they materialize, depending on timing, extent, and availability of other options.

In an embodiment, the historical programs stored in the program database 102 can comprise one or more subassemblies, representing the subassemblies or modular sub-components of a larger program. The subassemblies can have corresponding program event features, as well as linking features that link each subassemblies to other subassemblies within the program. The taxonomy of each and all subassemblies aids in forming an ontology for the subassemblies from a global perspective. The taxonomy or ontology can be considered a normalized view without constraints imposed by individual management or analysis tools.

In embodiments, subassemblies can include context attributes representative of context information about the subassembly. Context information relates to how, what, when, or where a subassembly might be used. For example, contexts can change throughout a program and might only be applicable during a specific phase. Contexts can come in different types according to program attributes or characteristics. Example types include those associated with a facility, a geo-location, weather, facility owner, safety, or other attributes.

A single unified view of subassemblies can be generated to ensure subassemblies maintain coherency among each other and the broader strategic program management plus (SPM+) ecosystem. In some embodiments, an owner, partner or the program management contractor can review, ratify, codify or otherwise recommend subassemblies for incorporation for specific program use.

In embodiments, the system 100 can include an inference engine configured to review subassemblies for proper definition, and to bind subassemblies together as desired. When binding subassemblies, the inference engine can use one or more specified contexts to consult its rules or subassembly rules to determine how multiple subassemblies should be bound. The engine can further instantiate the subassemblies (e.g., prepare a subassembly for use by an analysis tool, such as the risk analysis engine 101) by running an analysis predicated on one or more rule sets. Example analyses can include forwarding chaining assemblies to determine a possible end product, backward chaining from an end product to determine best subassemblies to fit a need, or case-based-reasoning to derive a subassembly solution matching start and end conditions. By using case-based-reasoning, the inference engine can discover a binding of subassemblies that meets desired boundary conditions.

In view that an inference engine leverages contexts (e.g., specified by an external tool, specified by a user, available to an assembly, etc.) of subassemblies, the inference engine can be configured to provide many subassembly related services. For example, an inference engine can comprise a replaceable rules module to change how it analyzes subassemblies for a program.

Additionally the inference engine can be outfitted with compliance rules where the compliance rules determine if proposed instantiated subassemblies comply with laws, standard, policies, or other types of regulations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A risk analysis system, comprising:
a program database storing historical program objects representing historical programs, each historical program object comprising program event features;
a risk database storing risk objects having risk drivers;
a risk analysis engine communicatively coupled to the program database and the risk database, the risk analysis engine configured to:
identify a reference program object selected from the historical program object in the program database as a template;
generate a program model by populating program event features of the template according to a current program's attributes;
generate a program outcome object representative of a program outcome by running at least one simulation of the program model, the program outcome object comprising outcome factors;
identify program risk factors from the outcome factors of the simulation;
derive a set of risks from the program risk drivers as a function of risk objects having risk drivers satisfying criteria depending on the program risk factors; and
configure an output device to present the set of risks to a user.

2. The risk analysis system of claim 1, wherein the program event features comprise at least a constraint coupling feature.

3. The risk analysis system of claim 1, wherein the program event features comprise at least an objective feature.

4. The risk analysis system of claim 1, wherein the program outcome comprises an event.

5. The risk analysis system of claim 1, wherein the program outcome comprises an intermediary status.

6. The risk analysis system of claim 1, wherein the program outcome comprises a measure of an objective.

7. The risk analysis system of claim 1, wherein the risk objects stored in the risk database are associated with correlated risks.

8. The risk analysis system of claim 1, wherein the risk database can be updated with bespoke risk objects in real-time.

9. The risk analysis system of claim 1, wherein the risk analysis engine is configured to derive the set of risks by using a risk identification algorithm.

10. The risk analysis system of claim 9, wherein the risk identification algorithm has a bias in seeking long tail, low probability events.

11. The risk analysis system of claim 1, wherein the set of risks comprises risk statistics.

12. The risk analysis system of claim 1, wherein the risk analysis engine is further configured to rank the set of risks according to the risks' impact.

13. The risk analysis system of claim 1, wherein the risk analysis engine is further configured to rank the set of risks according to probability of occurrence.

14. The risk analysis system of claim 1, wherein the risk analysis engine is further configured to rank the set of risks according to frequency of occurrence within the at least one simulation.

15. The risk analysis system of claim 1, wherein the set of risks comprises a chain of risk objects from the risk database.

16. The risk analysis system of claim 1, wherein the set of risks comprises correlated risks.

17. The risk analysis system of claim 1, wherein the set of risks comprises a risk object that is newly created and updated into the risk database.

18. The risk analysis system of claim 1, wherein the set of risks comprises a black swan risk.

19. The risk analysis system of claim 1, wherein the at least one simulation comprises a Monte Carlo simulation.

20. The risk analysis system of claim 1, wherein the at least one simulation comprises a simulation that takes into account of a Failure Mode and Effects Analysis.

21. The risk analysis system of claim 1, wherein the at least one simulation comprises a simulation that takes into account of a Fault Tree Analysis.

22. The risk analysis system of claim 1, wherein the risk analysis engine is further configured to generate the program outcome through running multiple simulations with same parameters to build statistics.

23. The risk analysis system of claim 1, wherein the risk analysis engine is further configured to generate the program outcome through running multiple simulations with different parameters to build statistics.

24. The risk analysis system further comprises a recommendation module configured to generate a financial instrument as mitigation against the identified set of risks.
